(19) United States
(12) Patent Application Publication
(10) Pub. No.: US 2007/0271157 A1
(43) Pub. Date: Nov. 22, 2007

(54) Method and system for providing a transaction browser

(76) Inventor: Dan Jonathan Rosenberg, San Jose, CA (US)

Correspondence Address: KENYON & KENYON LLP, ONE BROADWAY, NEW YORK, NY, 10004, US

(21) Appl. No.: 11/435,102

(22) Filed: May 15, 2006

(51) Int. Cl. G06Q 10/00

(52) U.S. Cl. 705/28

(57) ABSTRACT

A method and system for providing a transaction browser is provided. The browser may identify a role assigned to a user in response to a received user identity. The browser may identify a subset of application command pathways that are related to the identified role. The browser may display a set of first levels of the identified pathways via a computer user interface. The browser may display the identified pathways via the computer user interface in response to a user request.

### BACKGROUND

In order to view tasks, transactions and other resources, an enterprise system may include a transaction browser. The transaction browser may display visible tasks, transactions and other resources to the user and receive user selection of tasks, transactions and other resources to execute or view. Visible tasks, transactions and other resources may be a subset of all tasks, transactions and other resources available through applications installed on the enterprise system. The subset may be determined by the user's role in a role-based user access control system.

Role-based access control simplifies access control administration by managing user permissions to resources and objects in terms of user roles. In an enterprise system, there may be a plurality of users, each user associated with one or more user roles. Role-based access control allows administrators to specify access control in terms of the organizational structure of a company. A role defines the authorization permissions on some set of resources. Since the roles allow access to be granted in terms of a company's organizational model, it is more intuitive and natural for administrators to specify access control.

### BRIEF DESCRIPTION OF THE DRAWINGS

FIG. 1 illustrates a screen shot according to an embodiment of the present invention.

FIG. 1A illustrates a screen shot according to an embodiment of the present invention.

FIG. 1B illustrates a screen shot according to an embodiment of the present invention.

FIG. 2 illustrates a procedure for providing a transaction browser according to an embodiment of the present invention.

FIG. 3 illustrates a procedure for providing a transaction browser according to an embodiment of the present invention.

FIG. 4 illustrates a system for providing a transaction browser according to an embodiment of the present invention.

### DETAILED DESCRIPTION

A method is provided to display a transaction browser displaying all available and visible transactions to a user in a computer system utilizing a role-based access control system. The role-based access control system may determine which transactions are visible to the user based on the user's role. Each transaction may be associated with a category. A transaction browser may display all available transactions in a specific category. However, such a view makes it difficult for a user to find a particular transaction if he does not know the category associated with the transaction. To find a transaction associated with an unknown category, a transaction browser may make all transactions and all categories visible to the user.

One example embodiment of the present invention may be a procedure for providing a transaction browser. The procedure may identify a role assigned to a user in response to a received user identity, identify a subset of application command pathways that are related to the identified role, display a set of first levels of the identified pathways via a computer user interface, and display the identified pathways via the computer user interface in response to a user request. The set of first levels of the identified pathways may be displayed in a dedicated navigation menu area of the computer user interface. The role may be identified by retrieving it from a user database. The transaction browser may be executed as a shell program. The procedure may display a set of first levels of the second identified pathways via the computer user interface in response to a second identified subset of application command pathways and display the second identified pathways via the computer user interface in response to a user request. Each application command pathway may indicate a transaction to be executed. The procedure may execute the transaction in response to a user command. The user identity may be received at a server and the computer user interface may be displayed at a client terminal.

One example embodiment of the present invention may be a system for providing a transaction browser. The system may include a terminal, a user interface program executed on the terminal, a middleware application executed on the terminal in communication with the user interface, and an application executed on the terminal in communication with the middleware application, the application configured to execute a resource. The user interface may be configured to display a list of primary level resources associated with a user role of a user and a list of resources associated with the user role. The application may include an application engine, and a database. The database may include resource data, user data, and business logic. The user interface program may be a shell program. The resource may be a transaction configured to receive data from the user or a report configured to display data to the user. The system may include a second application executed on the terminal in communication with the middleware application, the second application configured to execute a second resource.

One example embodiment of the present invention may be a navigation procedure for a computer system, the procedure including authenticating a user and identifying a role associated with the user, identifying a subset of resources associated with the role, the subset of resources being related in a navigation hierarchy, displaying, in a navigation menu in a dedicated region of a user interface, members of a primary level of the hierarchy and a selection for a browser, when the browser is selected, displaying in a work area of the user interface the subset of resources, the resources displayed according to the navigation hierarchy, and when a member of the primary level is selected, displaying resources of lower levels associated with the primary member in the work area. The resources may be transactions to be executed by an application or reports to be viewed by the user.

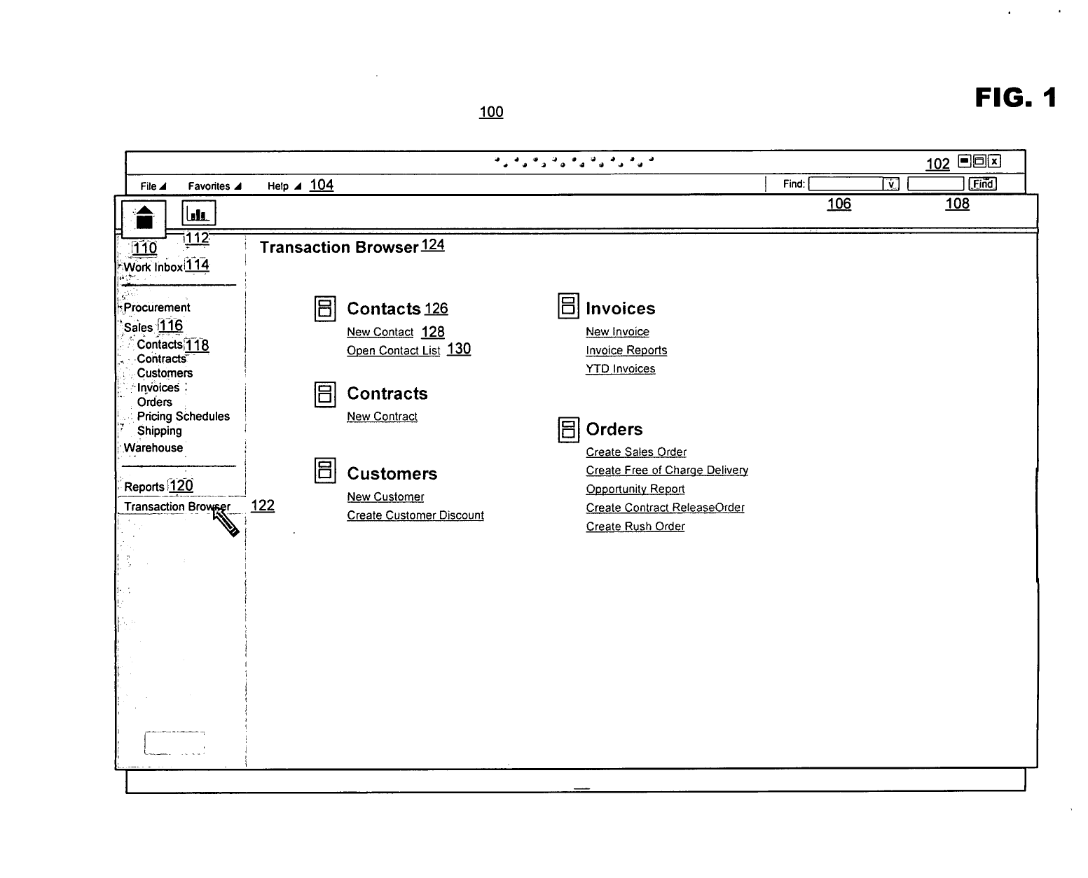

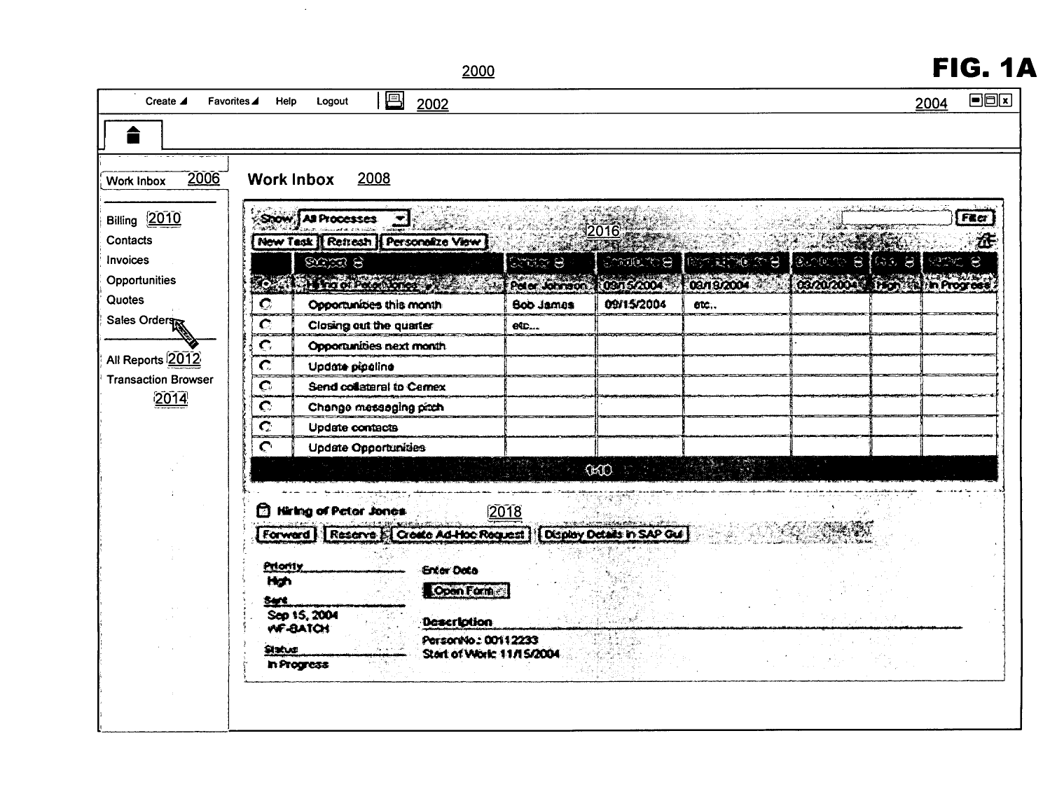

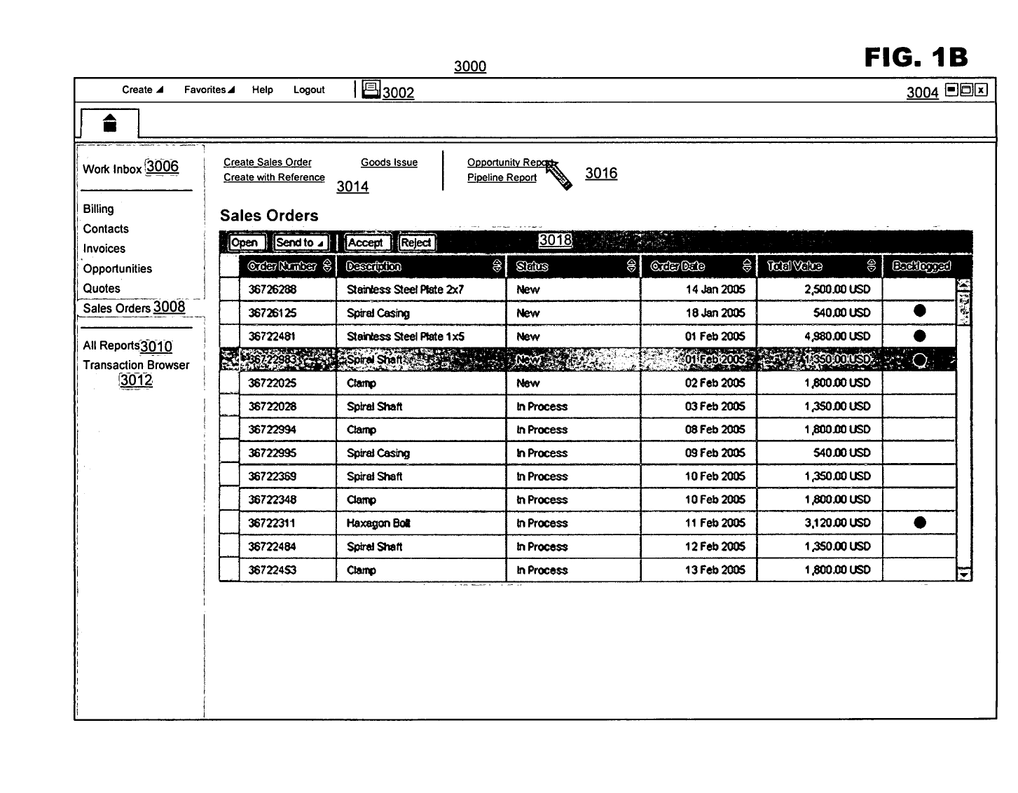

FIG. 1 illustrates a screen shot according to an embodiment of the present invention. The screen shot depicts a transaction browser 100 in a window of a system displaying all visible transactions organized by categories, where the transactions are visible based on the user's role in a role-based access control system. The display may be made to a user of the system.

Visible transactions may be selected from available transactions, based on applications installed on the system.

A transaction browser 100 may display all transactions available to a user based on the user's role or roles within a role-based access control system. Transactions are applications that receive data from the user. For example, creating a new sales order, entering contact information of a customer may be transactions.

A report browser may also be available. Reports are representations of data and information made to the user. For example, reports may be charts or tables of recent sales, upcoming deadlines, or other information.

The transaction browser 100 may include window control buttons 102. Window control buttons 102 may include buttons to minimize, restore up/down and close the transaction browser 100.

The transaction browser 100 may include a menu 104. The menu 104 may include menu categories such as file, favorites and help. Each menu category may include one or more menu items.

The transaction browser 100 may include a find text dropdown box 106. The find text dropdown box 106 may include a dropdown button that activates a dropdown text display area.

The dropdown text display area displays common search terms or a number of last used search terms.

The transaction browser 100 may include a find text entry box 108. The find text entry box 108 may receive user input of search terms to find in the transaction browser 100. The find text entry box 108 may include a find button which begins a search when clicked. The search may search among transactions and text of the transactions displayed by the transaction browser 100.

The transaction browser 100 may include a home button 110 which returns the user to a home page. The home page may include links to transactions, reports and applications available to the user. For example, the home page may be as depicted in FIG. 1A.

The transaction browser 100 may include a report button 112, which displays a list of reports available for display to the user when clicked. The transaction browser 100 may include other buttons or tabs that display other information.

The transaction browser 100 may include a work inbox link 114, which may display a list of outstanding tasks for the user to complete and other information when clicked. The work inbox may also include messages, announcements, and an aggregation of all information a user needs in his role. For example, clicking on the work inbox link 114 may take the user to a screen as depicted in FIG. 1A.

The transaction browser 100 may include one or more categories 116. The transaction browser 100 may include one or more transactions 118. A transaction 118 may be an application to be executed by the user, a task to be completed, or any other resource on the system available to the user. A user clicking on a category 116 may be taken to a filtered work inbox as depicted in FIG. 1B.

Each transaction 118 may be associated with a category 116. As depicted, contacts transaction 118 is in the sales category 116. Transactions 118 may be sorted into categories 116 based on user roles.

For example, a user who is in sales may have access to a view contacts application and a list of contact information. The view contacts application may be in a contracts category. The user may also have access to a form contract generator application, which creates new contracts based on user inputs. The form contract generator application may be in a contracts category. The user may also have access to a form order creator, which accepts input from the user regarding a sale and transmits it to the finance, manufacturing and shipping departments. The form order creator may be in an order category.

The transaction browser 100 may include a reports browser link 120, which displays a reports browser. The reports browser may be similar to the transaction browser 100 except it provides access to reports. For example, the system may generate reports periodically or in real-time. Reports may also be subject to access control based on the user's role or roles.

The transaction browser 100 may include a transaction browser link 122, which displays a transaction browser frame 124 in a main active area of the window when clicked. The transaction browser frame may display all transactions 128 and 130 visible to the user organized by categories 126.

Clicking on a category 126 may also take the user to a filtered work inbox, as depicted in FIG. 1B. Clicking on a transaction 128 or 130 may take the user to a screen displaying the selected transaction.

FIG. 1A illustrates a screen shot according to an embodiment of the present invention.

The screen shot may be a view of the user's work inbox 2000 in a window and may be displayed after a user clicks link 114 as depicted in FIG. 1. The work inbox 2000 may also be a default view or home page for a user who logs into the system.

The work inbox 2000 may include a menu 2002. The menu 2002 may include menu categories such as create, favorites, help, log out and print. Each menu category may include one or more menu items selectable by the user.

The work inbox 2000 may include window control buttons 2004. Window control buttons 2004 may include buttons to minimize, restore up/down and close the work inbox 2000.

The work inbox 2000 may include a work inbox link 2006. Clicking on the work inbox link 2006 may bring up the work inbox display 2008 in the active work space. The work inbox link 2006 may be similar to the work inbox link 114 of FIG. 1. The work inbox 2008 may also be set as a user's home page.

The work inbox 2000 may include categories 2010. Categories 2010 may be similar to categories 116 depicted in FIG. 1. Clicking on a category 2010 may display transactions associated with the category, similar to transactions 118 as depicted in FIG. 1.

The work inbox 2000 may include a reports browser link 2012. The reports browser link 2012 may be similar to the reports browser link 120 of FIG. 1.

The work inbox 2000 may include a transaction browser link 2014. Clicking on the transaction browser link may bring up the transaction browser as depicted in FIG. 1. The transaction browser link 2014 may be similar to the transaction browser link 122 of FIG. 1.

The work inbox 2000 may include a work inbox display 2008, where items relevant to the user are displayed. The work inbox 2000 may include a list of items 2016. Each item may be a message, outstanding transaction, incomplete task, or other resources on the system visible to the user and necessary to the user's role.

The work inbox 2000 may include a detailed view 2018 of an item selected in 2016. For example, details such as a send time, a priority level, a status indicator, and a description may be displayed. In addition, action buttons such as reply, display additional details, create form may be available to the user for acting on or completing the item.

FIG. 1B illustrates a screen shot according to an embodiment of the present invention. The screen shot may be a view of the user's filtered work inbox 3000 in a window and may be displayed after a user clicks a category 116 or category 126 as depicted in FIG. 1 or category 2010 as depicted in FIG. 1A. The filtered work inbox 3000 may be similar to the user's work inbox 2008 as depicted in FIG. 1A, but displaying items desired by the user and filtering out all other items. For example, items may be filtered by category.

A user may access transactions through either the transaction browser 100 depicted in FIG. 1, the work inbox 2000 depicted in FIG. 1A or the filtered work inbox 3000. Using the transaction browser may allow the user to view all categories and transactions available to him.

Using the work inbox may allow the user to see all items relevant to his immediate duties and tasks. Using the filtered work inbox may allow the user to see all items relevant to his selected filter conditions.

The filtered work inbox 3000 may include a menu 3002. The menu 3002 may be similar to the menu 2002 depicted in FIG. 1A.

The filtered work inbox 3000 may include window control buttons 3004. Window control buttons 3004 may be similar to window control buttons 2004 depicted in FIG. 1A.

The filtered work inbox 3000 may include a work inbox link 3006. Clicking on the work inbox link 3006 may bring up a work inbox as depicted in FIG. 1A. The work inbox link 3006 may be similar to the work inbox link 114 of FIG. 1.

The filtered work inbox 3000 may include categories 3008. Categories 3008 may be similar to categories 116 depicted in FIG. 1. In this screen shot, the sales orders category has been selected, thus filtering out all items in the work inbox 2000 as depicted in FIG. 1A that do not relate to Sales Orders.

The filtered work inbox 3000 may include a reports browser link 3010. The reports browser link 3010 may be similar to reports browser link 120 of FIG. 1.

The filtered work inbox 3000 may include a transaction browser link 3012. Clicking on the transaction browser link may bring up the transaction browser as depicted in FIG. 1. The transaction browser link 3011 may be similar to the transaction browser link 122 of FIG. 1.

The filtered work inbox 3000 may include a filtered work inbox displayed in an active area of the window.

The filtered work inbox 3000 may include links that open visible applications 3014. Visible applications may be applications installed on the system for which the user's role has been assigned access permissions. For example, applications in the Sales Orders category may include Create Sales Order, Create with Reference, and Goods Issued.

The filtered work inbox 3000 may include links that views visible reports 3016. For example, reports in the Sales Orders category may include Opportunity Report and Pipeline Report.

Other visible items and resources may be made available to the user depending on the user's role.

The filtered work inbox 3000 may include a list of items 3018. Each item may be a message, outstanding transaction, incomplete task, or other resources on the system visible to the user.

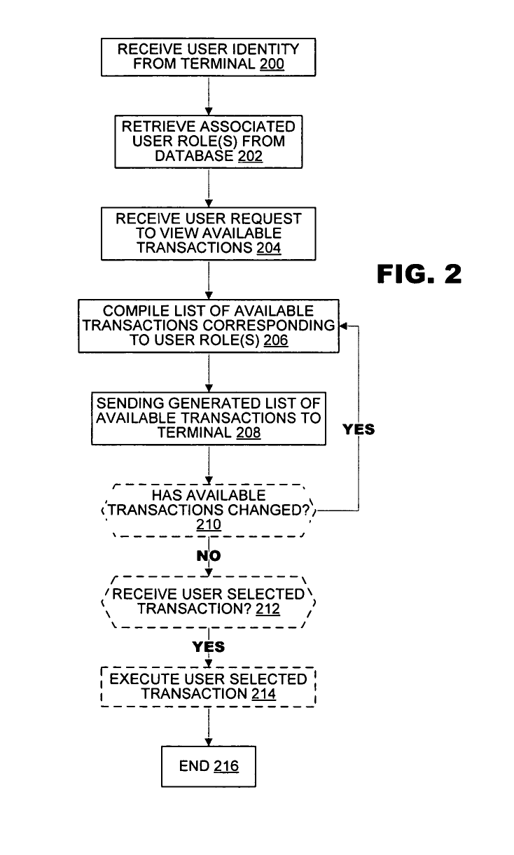

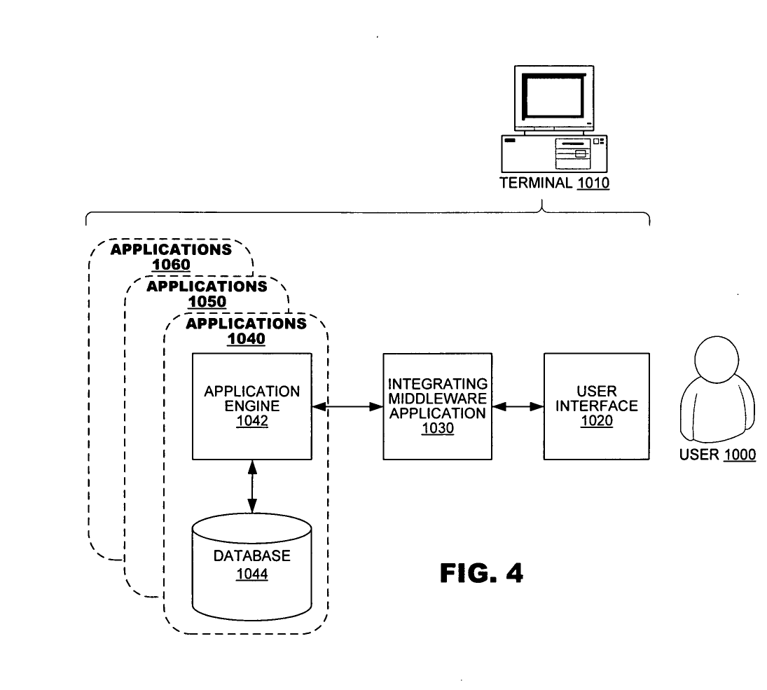

FIG. 2 illustrates a procedure for providing a transaction browser according to an embodiment of the present invention. The procedure may be implemented as a shell program executed on a terminal as depicted in FIG. 4 interacting with a user.

In 200, the procedure may receive a user identity at the terminal. The user identity may be a unique identifier within the system that identifies the user, for example, a user name. The user identity may be determined by a user's login information when logging into the terminal. The terminal may be a stand alone device such as a desktop computer or a work station, or a client device in communication with a server.

In 202, user roles associated with the user identity are retrieved. For example, each user identity may be associated with user roles assigned to the user. Example user roles may include: sales manager, shipping clerk, executive, or any other job description. The associated user roles for a user identity may be retrieved from a relational database.

In 204, the procedure may receive a user request to view all available and visible transactions. For example, the user may click on the transaction browser link 122 depicted in FIG. 1. The user may make such a request when he is looking for a transaction for which he does not know the category of.

In 206, the procedure may compile or generate a list of available and visible transactions corresponding to each user role of the user. A transaction may be available if an associated application is installed on the system. A transaction may be visible if the user has appropriate permissions and has been assigned an appropriate role to access the transaction. The procedure may examine each user role and determine the available transactions the user role has permissions for. The compiled list will represent all transactions the user is allowed to view.

In 208, the procedure may transmit the compiled list of available transactions to the terminal. The terminal may then display the list to the user and await the user's selection of a transaction to execute.

In 210, the procedure may optionally test whether available transactions have changed. For example, transactions available to a user role may be modified by the system or a system administrator. If such changes are detected, the procedure may proceed to 206, where a new list of available transactions is compiled and sent to the terminal in 208. The terminal may display the new list of available transaction to the user.

In 212, the procedure may optionally test whether a user selected transaction has been received yet. For example, the procedure may wait for the user to select a transaction from the list of available transaction transmitted in 208. The user may select a transaction by clicking on a link corresponding to a transaction as depicted in FIG. 1. If yes, the procedure may procedure to 214.

In 214, the procedure may optionally execute the user selected transaction selected in 212.

In 216, the procedure may end.

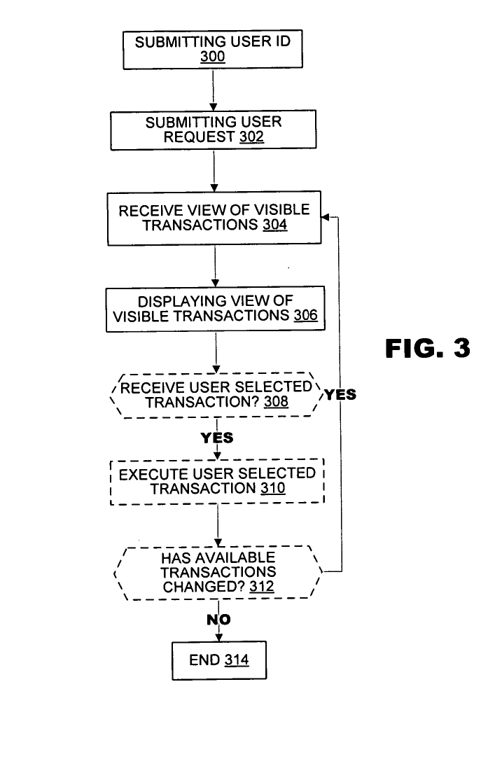

FIG. 3 illustrates a procedure for providing a transaction browser according to an embodiment of the present invention. The procedure may be implemented as a shell program executed on a terminal as depicted in FIG. 4 interacting with a user. The procedure may be implemented as a part of a transaction launcher environment.

In 300, the procedure may submit a user identity. For example, the user identity may be submitted to a server or a middleware application as depicted in FIG. 4. The user identity may be a unique identifier within the system that identifies the user, for example, a user name.

The user identity may be determined by a user's login information when logging into the terminal. The terminal may be a stand alone device such as a desktop computer or a work station, or a client device in communication with a server.

User roles associated with the user identity may be identified. For example, each user identity may be associated with user roles assigned to the user. Example user roles may include: sales manager, shipping clerk, executive, or any other job description. The associated user roles for a user identity may be retrieved from a relational database.

In 302, the procedure may submit a user request to view all available and visible transactions. For example, the user may click on the transaction browser link 122 depicted in FIG. 1. The user may make such a request when he is looking for a transaction for which he does not know the category of. In an example embodiment, the user request may be submitted together with the user identity.

In 304, the procedure may receive a view of available and visible transactions. For example, the view may be compiled in 206 of FIG. 2. The view may include a list of available and visible transactions corresponding to each user role of the user. A transaction may be available if an associated application is installed on the system. A transaction may be visible if the user has appropriate permissions and has been assigned an appropriate role to access the transaction. The procedure may examine each user role and determine the available transactions the user role has permissions for. The compiled list will represent all transactions the user is allowed to view.

For example, the view of available and visible transaction may be received from the server or a middleware application as depicted in FIG. 4.

In 306, the procedure may display the view of visible transactions received in 304. The view may be displayed through an output device at the terminal to the user. For example, the displayed view may be similar to the screen shot depicted in FIG. 1.

In 308, the procedure may optionally test whether a user selected transaction was received. For example, a user may select a transaction by clicking on a link corresponding to a transaction as depicted in FIG. 1. If yes, the procedure may proceed to 310.

In 310, the procedure may optionally execute the user selected transaction of 308.

In 312, the procedure may optionally check whether the available transactions have changed. For example, transactions available to a user role may be modified by the system or a system administrator. If such changes are detected, the procedure may proceed to 304, where a new list of available transactions is received and displayed in 306.

In 314, the procedure may end.

FIG. 4 illustrates a system for providing a transaction browser according to an embodiment of the present invention. The system may execute, for example, a procedure as depicted in FIGS. 2 and 3. A terminal 1010 may be available to a user 1000. The terminal 1010 may include an output device such as a display screen and an input device such as a keyboard or a mouse. For example, the terminal 1010 may be a personal or workstation computer, a laptop computer, a tablet computer, a personal digital assistant (PDA) or a wireless device such as a cell phone.

The terminal 1010 may include a processor configured to execute various application programs such as browser programs, word processing programs, spreadsheet programs, enterprise management applications and other applications. For example, the terminal 1010 may execute a user interface 1020. For example, the user interface 1020 may be implemented as a shell program and configured to display a list of visible transactions based on a user role.

The user interface 1020 may be in communication with an integrating middleware application 1030. The middleware application 1030 may interface between the user interface 1020 and applications 1040. Applications 1040 may include an application engine 1042 and a database 1044. More than one application engine may be provided in the system. For example, each application engine may execute a plurality of applications.

The application engine 1042 may execute different applications, such as a calendar software, a contacts management software, a customer data entry form, sales order creation form, or other applications. The database 1044 may include transaction data relevant to the applications offered on the terminal 1010. Data may include information for each transaction or report available through the applications 1040. Data may also include user data associated with the user 1000. Data may also include business logic defining available actions in applications 1040.

The terminal 1010 may include a plurality of applications. For example, applications 1050 and 1060 may also execute on the terminal 1010. Each of applications 1050 and 1060 may be similar to applications 1040, and include an application engine and a database. The applications 1040-1060, associated engines and databases may form or be part of a “back-end” responsive to a “front-end” component such as user interface 1020. For example, the back-end may include metadata and functionality configured to associate user information, such as a user role and/or identity, with corresponding role-based content to be presented in the user interface. The user interface may collect the user information, for example by way of a logon, and make a call to the back-end for the appropriate role-based content.

While the applications 1040, 1050 and 1060 may share a similar architecture and each possess an application engine and a database, they may possess functionality totally different from each other.

The terminal 1010 may include a network interface configured to communicate with a server. For example, the applications 1040 may be located at the server. In this example embodiment, the middleware application 1030 may communicate with the applications 1040 via the network interface.

Several embodiments of the present invention are specifically illustrated and described herein. However, it will be appreciated that modifications and variations of the present invention are covered by the above teachings and within the purview of the appended claims without departing from the spirit and intended scope of the invention.

We claim:

1. A method for providing a transaction browser, comprising:
responsive to a received user identity, identifying a role assigned to a user;
identifying a subset of application command pathways that are related to the identified role;
displaying a set of first levels of the identified pathways via a computer user interface; and
responsive to a user request, displaying the identified pathways via the computer user interface.

2. A method of claim 1, wherein the set of first levels of the identified pathways are displayed in a dedicated navigation menu area of the computer user interface.

3. A method of claim 1, wherein the role is identified by retrieving it from a user database.

4. A method of claim 1, wherein the transaction browser is executed as a shell program.

5. A method of claim 1, further comprising:
responsive to a second identified subset of application command pathways, displaying a set of first levels of the second identified pathways via the computer user interface; and
responsive to a user request, displaying the second identified pathways via the computer user interface.

6. A method of claim 1, wherein each application command pathway indicates a transaction to be executed.

7. A method of claim 6, further comprising:
executing the transaction in response to a user command.

8. A method of claim 1, wherein the user identity is received at a server and the computer user interface is displayed at a client terminal.

9. A system for providing a transaction browser, comprising:
a terminal;
a user interface program executed on the terminal, the user interface configured to display
a list of primary level resources associated with a user role of a user, and
a list of resources associated with the user role;
a middleware application executed on the terminal in communication with the user interface; and
an application executed on the terminal in communication with the middleware application, the application configured to execute a resource.

10. A system of claim 9, wherein the application further includes,
an application engine, and
a database.

11. A system of claim 10, wherein the database further includes,
resource data,
user data, and
business logic.

12. A system of claim 10, wherein the user interface program is a shell program.

13. A system of claim 10, wherein the resource is a transaction configured to receive data from the user.

14. A system of claim 10, wherein the resource is a report configured to display data to the user.

15. A system of claim 10, further comprising:
a second application executed on the terminal in communication with the middleware application, the second application configured to execute a second resource.

16. A navigation method for a computer system comprising:
authenticating a user and identifying a role associated with the user;
identifying a subset of resources associated with the role, the subset of resources being related in a navigation hierarchy;
displaying, in a navigation menu in a dedicated region of a user interface, members of a primary level of the hierarchy and a selection for a browser;
when the browser is selected, displaying in a work area of the user interface the subset of resources, the resources displayed according to the navigation hierarchy; and
when a member of the primary level is selected, displaying resources of lower levels associated with the primary member in the work area.

17. A navigation method of claim 16, wherein the resources are transactions to be executed by an application.

18. A navigation method of claim 16, wherein the resources are reports to be viewed by the user.
